(19) United States
(12) Patent Application Publication
(10) Pub. No.: US 2026/0099309 A1
(43) Pub. Date: Apr. 9, 2026

(54) WASM BYTECODE OPTIMIZATION METHODS, EXECUTION METHODS, COMPUTER DEVICES, AND STORAGE MEDIA

(71) Applicant: Ant Blockchain Technology (Shanghai) Co., Ltd., Shanghai (CN)

(72) Inventors: Wei ZHOU, Hangzhou (CN); Lei ZHANG, Hangzhou (CN)

(73) Assignee: Ant Blockchain Technology (Shanghai) Co., Ltd., Shanghai (CN)

(21) Appl. No.: 19/416,147

(22) Filed: Dec. 11, 2025

Related U.S. Application Data
(63) Continuation of application No. PCT/CN2023/134977, filed on Nov. 29, 2023.

(30) Foreign Application Priority Data
Jul. 24, 2023 (CN) 202310914541.4

(51) Int. Cl. G06F 8/41

(52) U.S. Cl. CPC G06F 8/443

(57) ABSTRACT

A WebAssembly (Wasm) bytecode optimization method and device is provided. In an implementation, the method includes: reading and parsing Wasm bytecode to obtain a Wasm module object, generating a linear memory and filling the linear memory based on the Wasm module object, executing a start function in the Wasm module object and modifying the linear memory based on an execution result of the start function, replacing a corresponding data segment in the Wasm module object with data in a modified linear memory, and encoding a Wasm module obtained by replacing the data segment and storing the encoded Wasm module as Wasm bytecode.

### CROSS-REFERENCE TO RELATED APPLICATIONS

This application is a continuation of PCT Application No. PCT/CN2023/134977, filed on Nov. 29, 2023, which claims priority to Chinese Patent Application No. 202310914541.4, filed on Jul. 24, 2023, and each application is hereby incorporated by reference in its entirety.

### TECHNICAL FIELD

Embodiments of this specification pertain to the field of compilation technologies, and in particular, relate to Wasm bytecode optimization methods, execution methods, computer devices, and storage media.

### BACKGROUND

WebAssembly is an open standard developed by a W3C community group, is a secure, portable low-level code format specially designed for efficient execution and compact presentation, can run with near-native performances, and provides a compilation target for languages such as C, C++, Java, and Go. WASM virtual machines are originally designed to resolve increasingly severe performance problems of Web applications. The WASM virtual machines are adopted by more non-Web items due to superior characteristics of the WASM virtual machines, for example, replace blockchain smart contract execution engines EVMs.

### SUMMARY

An objective of this application is to provide Wasm bytecode optimization methods, methods for executing an optimized Wasm bytecode, computer devices, and storage media, including:

A Wasm bytecode optimization method, including: reading and parsing Wasm bytecode, to obtain a Wasm module object; creating a linear memory and filling the linear memory based on the Wasm module object obtained through parsing; executing a start function in the Wasm module object, and modifying the linear memory based on an execution result of the start function; replacing a corresponding data segment in the Wasm module object with data in a modified linear memory; and encoding a Wasm module obtained by replacing the data segment, and storing the encoded Wasm module as Wasm bytecode.

A method for executing an optimized Wasm bytecode, including: reading and parsing the optimized Wasm bytecode, to obtain a Wasm module object; creating a linear memory and filling the linear memory based on the Wasm module object obtained through parsing; and executing code in a code segment in the Wasm module object.

A computer device, including: a processor; and a storage, where the storage stores a program, and when the processor executes the program, the following operations are performed: reading and parsing an optimized Wasm bytecode, to obtain a Wasm module object; creating a linear memory and filling the linear memory based on the Wasm module object obtained through parsing; and executing code in a code segment in the Wasm module object.

A storage medium, configured to store a program, where when the program is executed, the following operations are performed: reading and parsing Wasm bytecode, to obtain a Wasm module object; creating a linear memory and filling the linear memory based on the Wasm module object obtained through parsing; executing a start function in the Wasm module object, and modifying the linear memory based on an execution result of the start function; replacing a corresponding data segment in the Wasm module object with data in a modified linear memory; and encoding a Wasm module obtained by replacing the data segment, and storing the encoded Wasm module as Wasm bytecode.

According to the above-mentioned embodiments, in a subsequent process of loading and executing the optimized Wasm bytecode, overheads caused by repeatedly executing the start function are avoided, thereby improving program running performance.

### BRIEF DESCRIPTION OF DRAWINGS

To describe the technical solutions in the embodiments of this specification more clearly, the following briefly describes the accompanying drawings needed for describing the embodiments. Clearly, the accompanying drawings in the following descriptions show merely some embodiments of this specification, and a person of ordinary skill in the art can still derive other drawings from these accompanying drawings without creative efforts.

FIG. 1 is a schematic diagram illustrating a compilation and execution process of a Java program, according to one or more embodiments;

FIG. 2 is a flowchart illustrating a process in which a compiler can compile Java source code into a Wasm file;

FIG. 3 is a schematic diagram illustrating a bytecode structure and a virtual machine module, according to one or more embodiments;

FIG. 4 is a flowchart illustrating a method, according to one or more embodiments;

FIG. 5 is a schematic diagram illustrating a Wasm file, a linear memory, and a managed memory, according to one or more embodiments;

FIG. 6 is a schematic diagram illustrating a Wasm file, a linear memory, and a managed memory, according to one or more embodiments;

FIG. 7 is a schematic diagram illustrating a Wasm file, a linear memory, and a managed memory, according to one or more embodiments;

FIG. 8 is a schematic diagram illustrating a Wasm file, a linear memory, and a managed memory, according to one or more embodiments;

FIG. 9 is a flowchart illustrating a method, according to one or more embodiments;

FIG. 10 is a schematic diagram illustrating creating and deploying a smart contract in a blockchain network, according to one or more embodiments;

FIG. 11 is a schematic diagram illustrating creating, deploying, and calling a smart contract in a blockchain network, according to one or more embodiments;

FIG. 12 is a schematic diagram illustrating creating, deploying, and calling a smart contract in a blockchain network, according to one or more embodiments; and

FIG. 13 is a schematic diagram illustrating a bytecode structure and a virtual machine module, according to one or more embodiments.

### DESCRIPTION OF EMBODIMENTS

To make a person skilled in the art better understand the technical solutions in this specification, the following clearly and comprehensively describes the technical solutions in the embodiments of this specification with reference to the accompanying drawings in the embodiments of this specification. Clearly, the described embodiments are merely some but not all of the embodiments of this specification. All other embodiments obtained by a person of ordinary skill in the art based on the embodiments of this specification without creative efforts shall fall within the protection scope of this specification.

High-level computer languages are convenient for people to write, read, communicate, and maintain, while machine languages can be directly interpreted and executed by computers. A compiler can take a source program in an assembly or high-level computer language as an input and translate the source program into an equivalent program with target language machine code. Source code is generally written in a high-level language, such as C or C++. A target is object code in a machine language, sometimes also referred to as machine code. Further, the machine code (or referred to as “microprocessor instructions”) can be executed by a CPU. This method is generally referred to as “compiled execution”.

Compiled execution generally does not have cross-platform scalability. There are CPUs from different manufacturers, brands, and generations, but instruction sets supported by these different CPUs are different in many cases, such as an x86 instruction set and an ARM instruction set, and instruction sets supported by CPUs from the same manufacturer and the same brand but different generations are not exactly the same. Therefore, the same program code written in the same high-level language may be converted into different machine code by compilers on different CPUs. Specifically, in a process of converting program code written in a high-level language into machine code, the compiler performs optimization based on characteristics of a specific CPU instruction set (for example, a vector instruction set) to increase a program execution speed, and such optimization is usually related to specific CPU hardware. Therefore, the same machine code can run on an x86 platform, but possibly cannot run on another ARM. Even for the same x86 platform, because the instruction set is constantly enriched and extended over time, machine code running on different generations of x86 platforms also varies. Moreover, because execution of the machine code needs an operating system kernel to schedule a CPU, even for the same hardware, different machine code may be supported in different operating systems.

Different from compiled execution, there is also a program running mode known as “interpreted execution”. For example, for high-level languages such as Java and C#, a function of the compiler in this case is to compile source code into bytecode in a universal intermediate language.

For example, Java source code in a Java language is compiled into standard bytecode by a Java compiler. Here, the compiler does not target an instruction set of any actual hardware processor, but describes a set of abstract standard instructions. The compiled standard bytecode generally cannot run directly on a hardware CPU. Therefore, a virtual machine, that is, a JVM, is introduced. The JVM runs on a specific hardware processor to interpret and execute the compiled standard bytecode.

The Java virtual machine, JVM for short, is a virtual computer usually implemented by emulating or simulating various computer functions on an actual computer. The JVM masks information related to specific hardware platforms, operating systems, etc., allowing a Java program to run on various platforms without any modification as long as standard bytecode capable of running on the Java virtual machine is generated.

A very important feature of the Java language is platform independence. Use of the Java virtual machine is the key to achieving this feature. Generally, if a high-level language is to run on different platforms, the high-level language at least needs to be compiled into different target code. After the Java virtual machine is introduced, the Java language does not need to be recompiled when running on different platforms. The Java language uses the Java virtual machine to mask information related to specific platforms. Therefore, as long as the Java language compiler generates target code (bytecode) that runs on the Java virtual machine, the target code can run on various platforms without any modification. When executing the bytecode, the Java virtual machine interprets the bytecode into machine instructions for execution on a specific platform. This is why Java can “run anywhere after being compiled once”. Therefore, as long as it is ensured that the JVM can correctly execute a .class file, the file can run on different operating system platforms such as Linux, Windows, and MacOS.

The JVM runs on a specific hardware processor and is responsible for interpreting and executing bytecode for the specific processor on which the JVM runs. The JVM also masks these underlying differences and presents standard development specifications to developers. Actually, when executing the bytecode, the JVM eventually interprets the bytecode into machine instructions for execution on the specific platform. Specifically, after receiving the input bytecode, the JVM interprets instructions one by one and translates the instructions into machine code suitable for running on the current machine. These processes are interpreted and executed, for example, by an interpreter. As such, a developer who writes a Java program does not need to consider a hardware platform on which the written program code is to be run. Development of the JVM is completed by a professional developer of a Java organization to adapt the JVM to different processor architectures. So far, there are only a limited quantity of mainstream processor architectures, such as X86, ARM, RISC-V, and MIPS. After the professional developer ports the JVM to platforms supporting these types of specific hardware, the Java program can theoretically run on all machines. Porting of the JVM is usually provided by professional personnel of a Java development organization, which greatly reduces burden on Java application developers.

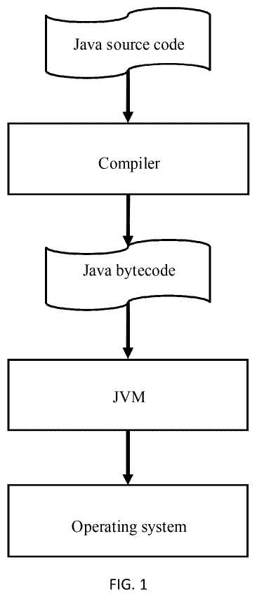

A brief process of compiling and executing the Java program is shown in FIG. 1. Java source code developed by a developer generally has an extension .java. After a source file is compiled by the compiler, a file with an extension .class is generated, and the .class file is bytecode. The bytecode includes a bytecode instruction, also referred to as opcode, and further includes an operand. The JVM parses the opcode and operands to complete program execution. When running the .class file by using a Java command, the bytecode in the .class file is actually loaded and executed by the Java virtual machine (JVM). The Java virtual machine is a core part for running the Java program, and is responsible for explaining and executing the Java bytecode. When the JVM loads and executes the bytecode in the .class file, it is actually equivalent to starting a JVM process in an operating system and applying for a part of memory from the operating system. This part of memory is generally managed directly by the JVM, and can specifically include a method area, a heap area, a stack area, etc. The JVM interprets and executes the Java program line by line based on an instruction of the bytecode. In an execution process, the JVM performs operations such as garbage collection, memory allocation, and release based on needs, to ensure normal running of the Java program. The loaded bytecode is translated by the JVM, which specifically includes two execution methods. One common execution method is interpreted execution, which means that the opcode and operands are translated into machine code and then handed over to the operating system for running. The other execution method is just in time (JIT), which means just-in-time compilation. In this method, the bytecode is compiled into machine code under certain conditions before execution.

Interpreted execution brings cross-platform portability. However, because execution of the bytecode goes through an intermediate translation process on the JVM, execution efficiency is not as high as efficiency of the above-mentioned compiled execution. This efficiency difference can sometimes even be up to dozens of times.

As mentioned above, during running of the Java program, the Java source code needs to be compiled into the Java bytecode, i.e. the .class file, and is then loaded and interpreted by the JVM. Therefore, a size of the .class file exerts certain impact on performance of the Java program. The smaller .class file usually means a faster loading speed and less memory occupation. When the Java virtual machine loads the .class file, the .class file needs to be parsed into an internal data structure, and then stored in the memory. The smaller .class files can be parsed and loaded faster, reducing loading time and memory occupation. In addition, the smaller .class file can be transmitted and stored faster, thereby helping improve overall performance of the Java program. When the .class file is transmitted on a network or stored on a disk, the smaller file needs a lower bandwidth and smaller storage space, and can be loaded or read faster, thereby accelerating a start speed and a response speed of a program.

To reduce the size of the .class file and provide a standard API, a large quantity of standard libraries are integrated into the JVM, and can be depended on and used by the Java program. For example, the Java source code developed by the developer includes two files, Person .java and Main .java, and a header of the Main .java file declares import of Person. Actually, Main and the Person file on which Main depended involve more depended classes during running, such as a default parent class and an ancestor class (a specific example is an indirectly depended string class String .class). If the JVM does not integrate a large quantity of depended libraries, Person, Main, and depended classes need to be compiled together in a compilation process, but there are more compiled .class files obtained as such, and a total size is also larger. After the JVM integrates a large quantity of standard libraries, the JVM needs to load fewer .class files externally by using a class loader during execution of the Java program, and the size is also smaller, but the depended classes still need to be loaded internally, for example, through a local file or a network. Another aspect is a dynamic loading feature of the JVM. As mentioned above, when the JVM executes the .class files of the Java bytecode, such as Person .class and Main .class in the above example, the JVM needs to load many depended class files in addition to loading the two bytecode files. The dynamic loading feature means that the JVM does not load all classes into the memory once, but loads classes based on needs. Specifically, only when the JVM uses a class that is not loaded, the JVM loads the class. The dynamic class loading feature of the JVM allows the Java program to control loading of different implementation classes based on conditions during running, thereby reducing memory usage. The memory usage directly affects execution efficiency of the JVM.

Java and other languages use virtual machines that run instruction sets on general-purpose hardware like x86, and then execute their own “assembly language” (for example, Java bytecode). Actually, a web platform also uses a virtual machine environment similar to Java and Python in a browser. The browser provides a virtual machine environment to execute JavaScript or some other scripting languages, thereby implementing interactive behaviors on HTML pages and some specific behaviors on web pages. For example, a specific behavior on a web page is to embed a dynamic text. As service needs are increasingly complex, development logic of a front end also becomes more complex, accompanied by an increasing amount of code, and a longer project development cycle. In addition to the complex logic and the large amount of code, another reason is an inherent flaw of JavaScript-lack of static variable types, which reduces efficiency. Specifically, a JavaScript engine caches and optimizes a function that is executed frequently in JavaScript code. For example, the JavaScript engine compiles the code into machine code, which is then packaged and sent to a JIT compiler, and compiled by the JIT compiler into machine code; and when this function is executed again next time, the compiled machine code is executed directly. However, JavaScript uses a dynamic variable, and this variable may be an array last time and may become an object next time. Therefore, the optimization performed by the JIT compiler last time becomes ineffective, and optimization needs to be performed again next time.

In 2015, WebAssembly (also abbreviated as Wasm) emerged. WebAssembly is an open standard developed by the W3C Community Group. It is a secure and portable low-level code format specially designed for efficient execution and compact representation, capable of running with near-native performance. Web Assembly is code compiled by a compiler, with a small size and a high startup speed. It is completely independent of JavaScript in terms of syntax, while providing a sandboxed execution environment. WebAssembly uses a static type to improve execution efficiency. In addition, WebAssembly brings many programming languages to the web. Moreover, WebAssembly further simplifies some execution processes, also resulting in a significant improvement in execution efficiency.

WebAssembly is a completely new format that is portable, small in size, fast to load, and compatible with the web. It can be used as a compilation target for C/C++/Rust/Java, etc. WebAssembly can be considered as a universal instruction set for x86 hardware on the web platform. As an intermediate language, WebAssembly interfaces with higher-level languages such as Java, Python, Rust, and C++, so that all these languages can be compiled into a unified format for running on the web platform.

For example, a source file developed in the C++ language generally has an extension .cpp. The cpp file can be compiled by the compiler to generate bytecode in a Wasm format. Similarly, a source file developed in the Java language generally has an extension .java. The java file can be compiled by the compiler to generate bytecode in the Wasm format. The bytecode in the Wasm format can be encapsulated into a wasc file. The wasc is a file that combines bytecode and an Application Binary Interface (ABI). The WebAssembly virtual machine (which also known as the Wasm virtual machine or Wasm running environment, and is the virtual machine running environment for executing the WASM bytecode) implemented based on the W3C community open standards is implemented by loading the Wasm bytecode during running and interpreting and executing the Wasm bytecode.

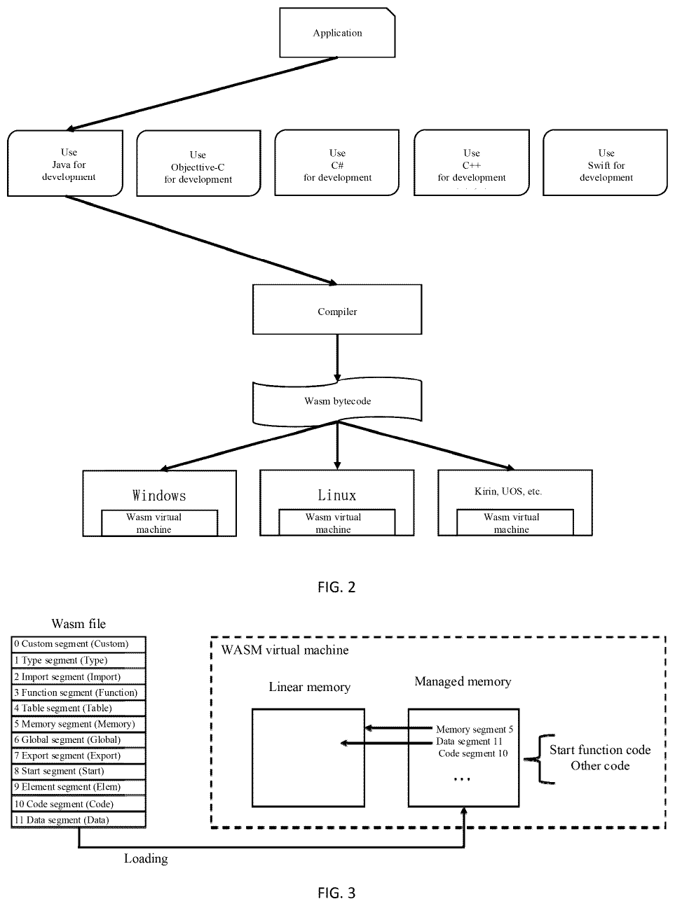

For example, to achieve cross-platform development of an application, Java is used to complete development on a Linux platform, Objective-C is used for development on an iOS, C# is used for development on a Windows platform, . . . . With Wasm, it is only necessary to choose any language, compile the language into Wasm, and distribute Wasm to various platforms. For example, as shown in FIG. 2, Java is used for development, Wasm bytecode can be obtained after compilation by a compiler, and the Wasm bytecode can run on various platforms integrated with a Wasm virtual machine.

WASM virtual machines are originally designed to resolve increasingly severe performance problems of Web applications. The WASM virtual machines are adopted by more non-Web items due to superior characteristics of the WASM virtual machines, for example, replace blockchain smart contract execution engines EVMs.

Compilation generally includes two types: single-file compilation and multi-file joint compilation.

In the single file compilation, all program code is included in a source file and can be written in any programming language. During compilation, the compiler compiles the source file into an object file. The object file can be, for example, a binary file of machine code and some metadata, or can be .class or .o. Then, a linker links the object file to another file (for example, a depended file such as a static library or a dynamic library), to generate a final executable program or library file. A main task of the linker here is to match and link an undescribed symbol (for example, a function or a variable) in the object file to a definition in the another file.

The multi-file joint compilation is to divide a program or library into a plurality of files for compilation and compile these files into one executable file or library file. In general, each source file in a plurality of separate files is used to implement one function or a group of related functions. After the compiler compiles each source file into an object file, similarly, the linker links a plurality of object files to form one executable file or library file. A main task of the linker is also to match and link an undescribed symbol (for example, a function or a variable) in the object file to a definition in another object file or library file. In comparison, the multi-file joint compilation has better maintainability and scalability. The plurality of files are used to write a program, to organize code more clearly and encapsulate different functions in different files for easy modification and maintenance. In addition, the multi-file joint compilation can effectively alleviate code repetition and dependency problems, and can improve compilation efficiency and reusability.

In processes of developing programs in many high-level languages, such as developing C++ programs, a plurality of source files can be used to write code, are compiled into a plurality of object files, and are finally linked to form one executable file or library file. In this process, only one source file/object file includes a main( ) function, and the main( ) function serves as an entry point of a program. Another object file includes various definitions, declarations, and implementations for use by the main( ) function. This method enables the program to conveniently perform modular programming, and alleviates code repetition and dependency problems. The Java program is similar. One Java program has only one entry point, but can include a plurality of classes and a plurality of packages. When the program starts, the JVM automatically executes the main( ) function in the class including the entry point (an entry function of a program in Java is specifically public static void main (String[ ] args), which is a start point of the program in Java). Methods in other classes can be called by the main( ) function in the Main class, to implement various functions.

As described above, the Java program can be compiled into the Wasm bytecode, and the Wasm bytecode can run on various platforms integrated with the Wasm virtual machine. When the Java program is compiled into WebAssembly bytecode, the compiler can automatically generate a start function and place the start function in the WebAssembly bytecode. The start function can serve as an entry point of a WebAssembly module, and can be configured to: perform initialization of the Java virtual machine, prepare a running environment for the Java program (for example, load a necessary class library), etc. In addition, the compiler inserts a main function of the Java program into the start function of the compiled WebAssembly bytecode, to start the main function of the Java program by calling the start function, thereby starting execution of the entire Java program. The start function in the Wasm bytecode performs initialization of the Java virtual machine and prepares the running environment for the Java program, for example, includes initialization of a heap in Java, calling of a static construction function of each Java class, and initialization of garbage collection. Another high-level language is similar, and can also be compiled into a WebAssembly module by using a WebAssembly compiler, and the compiled WebAssembly module includes a start function.

In an example, source code written in a certain high-level language (for example, languages such as go, TypeScript, Python) can be the following or similar code:

| | |
|---|---|
| 1. | global int sum = 0; |
| 2. | |
| 3. | export func main( ): Int { |
| 4. | print(“hello”); |
| 5. | return sum; |
| 6. | } |
| 7. | |
| 8. | sum = 1; |

As shown in the above-mentioned source code, the 1^{st} line declares and describes a global variable sum in this high-level language, and assigns a value of 0. The 3^{rd} line to the 6^{th} line are main functions, including executing a print function and returning a value of sum. The 8^{th} line assigns a value of 1 to sum. The 8^{th} line is an operation in a global scope.

Wasm bytecode (pseudocode) generated by compiling the source code is as follows:

| 1. | ( | |
|---|---|---|
| 2. | (data 0 “\0”) | |
| 3. | (func $main | |
| 4. | | (print “hello”) |
| 5. | i32.load 0) | |
| 6. | | |
| 7. | (func $start | |
| 8. | | (i32.store 0 (i32.const 1)) |

| | |
|---|---|
| 9. | (start $start)//marked as a start function |
| 10. | ) |

As shown in the above-mentioned Wasm code, the 2^{nd} line assigns a value of 0 to a variable whose index location is 0 (which is indicated by \0 in double quotes, and corresponds to sum in the source code, where an index is 0 because sum is in the most front location in the source code); the 3^{rd} line and the 5th line are main functions, including executing a print function and returning a value of a variable (namely, sum in the source code) whose index location is 0; the start function in the 7^{th} line to the 10^{th} line includes the operation corresponding to the global scope in the 8^{th} line, because such an operation in the global scope is suitable for being performed first in the start function; the 9^{th} line indicates that the start function is marked as the start function of the Wasm bytecode, namely, an entry function; and the 3^{rd} line is other function code, and usually can be Wasm bytecode corresponding to a main( )/apply( ) function in the source code. After the entry function start is executed, code starting from the 3^{rd} line continues to be executed.

It can be seen that although there is no start function in the source code, the start function can be automatically generated in a process of compiling the source code into the Wasm module. A function of the start function includes executing initialization of the Java virtual machine and preparing the running environment for the Java program. Because a Wasm specification specifies that the start function is automatically executed after the module is loaded, a main entry of the Java program is usually called in the start function. As such, a role of the start function is equivalent to the entry point of the program. Therefore, the start function can be automatically executed after the module is instantiated, and does not need to be explicitly called.

When the Wasm bytecode is executed, the WebAssembly virtual machine loads and runs the Wasm bytecode. FIG. 3 shows content and a loading process of one piece of Wasm bytecode. Content of each segment (or section) is specifically as follows:

TABLE 1
Segments and content descriptions included in a Wasm module

| ID | Segment | Description |
|---|---|---|
| 0 | Custom segment | Mainly used to store data such as debugging information |
| | (Custom) | |
| 1 | Type segment | Stores a function parameter list of an imported function and module |
| | (Type) | internal function |
| 2 | Import segment | Used to store a function name and a function parameter index of an |
| | (Import) | imported function |
| 3 | Function segment | Used to store a function index value |
| | (Function) | |
| 4 | Table segment | Used to store an object reference, where the table segment can |
| | (Table) | implement a function (call_indirect instruction) of a function |
| | | pointer, and can be imported from an external host or exported to an |
| | | external host environment |
| 5 | Memory segment | Used to store runtime dynamic data of a program, where the |
| | (Memory) | runtime dynamic data can be imported from an external host or |
| | | exported to an external host environment |
| 6 | Global segment | Used to store all variable values |
| | (Global) | |
| 7 | Export segment | Used to store a function name and a function parameter index of an |
| | (Export) | exported function |
| 8 | Start segment | Used to specify a function index value used when a module is |
| | (Start) | initialized |
| 9 | Element segment | A table segment is not explicitly initialized, and the element |
| | (Elem) | segment is used to store an index value of a function |
| 10 | Code segment | Used to store instruction code of a function |
| | (Code) | |
| 11 | Data segment | Used to store static data of an initialized memory |
| | (Data) | |

The memory segment (Memory Section) 5 can describe a basic situation of a linear memory segment used in a Wasm module, for example, an initial size and a maximum available size of the memory segment. A data segment (Data Section) 11 describes some meta information filled in a linear memory, and stores data that may be used by various modules, for example, a segment of string and some numeric values. data 0 (corresponding to sum=0 in the source code) in the above-mentioned Wasm code example is a part of content of Data Section. In addition, Data Section can further include an underlying implementation of memory allocation in some source codes such as a used standard library such as a malloc function and initialization content of calling, garbage collection, etc. of some construction functions.

In general, a linear memory of WebAssembly stores two types of content:

A heap is used to store various data structures such as objects and arrays.

A stack is used to store other temporary information used when a local variable and a function are called.

The linear memory of WebAssembly is continuous memory space, and is used to store data used during running of a program. The linear memory of WebAssembly includes a plurality of pages, and a size of each page is 64 KB. A size of the linear memory is allocated and managed by page. When the WebAssembly module is started, an initial size and a maximum size of the linear memory need to be specified. If the program needs more memory space, more memory can be dynamically allocated by extending the linear memory to more pages. Each byte in the linear memory can be directly accessed by the Wasm virtual machine. WebAssembly provides a plurality of types of instructions to support read/write operations on the linear memory, for example, i32.load, i32.store, i64.load, and i64.store. These instructions can read or write memory data of a specified address, or can perform operations such as offset and alignment. The linear memory is one of core mechanisms of WebAssembly, and provides an efficient and reliable memory management mode, so that the WebAssembly module runs more efficiently and stably.

After the Wasm bytecode is loaded on the WebAssembly virtual machine, one linear memory can be allocated as memory space used by the WebAssembly bytecode. Specifically, one linear memory can be allocated based on the memory segment 5 in the above-mentioned Wasm file, and content in a data segment 11 is filled in the linear memory. In addition, many other content in the Wasm file can be stored in a memory area managed by a host environment (for example, a browser or another application program) during loading, rather than the linear memory of WebAssembly. A specific storage location depends on implementation details of the host environment, and this part of memory area is usually not directly accessible to WebAssembly code. Such areas are generally referred to as managed memory. A code segment (Code Section) 10 in the Wasm file stores a specific definition of each function, that is, a cluster of Wasm instruction sets corresponding to a function body. The Wasm instruction set of the start function can be stored in the code segment 10. In addition, a part of main( )/apply( ) in the source code can also be stored in the code segment 10.

With reference to the above-mentioned example, the 2nd line (data 0 “\0”) in the Wasm bytecode is a data segment; and a part in brackets starting from func in the 3^{rd} line and the 7^{th} line is a code segment.

A specific example of the above-mentioned content can be shown in FIG. 3. In addition, each time the Wasm module is loaded into the virtual machine and executed, content in the start function is repeatedly executed, and then the remaining code is executed. Specifically, after the Wasm bytecode is loaded in the WebAssembly virtual machine, one linear memory can be allocated, based on content of the memory segment 5 in the managed memory, as memory space used by the WebAssembly bytecode, and the content in the data segment 11 is filled in the linear memory. For example, in the above-mentioned Wasm code example, a location whose index location is 0 in the 2^{nd} line is assigned with a value of 0, that is, is located in the data segment 11. Further, the WebAssembly virtual machine executes code in the code segment 10 in the managed memory. Here, the code is mainly the part in the brackets starting from func in the 3^{rd} line and the 7th line. This example includes two functions: main and start. As described above, the start function is equivalent to an entry of the code. Therefore, content in the start function is executed, and then another code (namely, code of the main function here) is executed. In a process of executing the start function, data in the linear memory may be modified. For example, the 8^{th} line (corresponding to “sum=1;” in the 8th line in the source code) in the Wasm bytecode is to modify the variable with the same index location 0 in the data segment to 1.

The above-mentioned examples are simple. Actually, there may be some more complex situations. To make a description and keep the description as brief as possible, the source code and the Wasm bytecode are modified as follows:

| | |
|---|---|
| 1. | global int sum = 0; |
| 2. | |
| 3. | export func main( ): int { |
| 4. | print(“hello”); |
| 5. | return sum; |
| 6. | } |
| 7. | func fib(n: int): int { |
| 8. | if (n < 2) { return 1; } |
| 9. | return fib(n−1) + fib(n−2); |
| 10. | } |
| 11. | sum = fib(5);//Replace sum=1 in a signature example with |

more complex sum=fib(5) here

As shown in the above-mentioned source code, the 1^{st} line declares and describes a global variable sum in this high-level language, and assigns a value of 0. The 3^{rd} line to the 6^{th} line are main functions, including executing a print function and returning a value of sum. The 7^{th} line to the 10^{th} line describe a Fibonacci function fib(n), and the n^{th} term of a Fibonacci number sequence is calculated based on an input parameter n. The 11^{th} line assigns a value of fib(5) to sum. Similarly, the 7^{th} line to the 11^{th} line is an operation in the global scope.

Wasm bytecode (pseudocode) generated by compiling the source code is as follows:

| 1. | ( | |
|---|---|---|
| 2. | (data 0 “\0”) | |
| 3. | (func $main | |
| 4. | | (print “hello”) |
| 5. | i32.load 0) | |
| 6. | ... | |
| 7. | (func $start | |
| 8. | | i32.store 0 (call fib 5)) |

| | |
|---|---|
| 9. | (start $start)//marked as a start function |
| 10. | ) |

As shown in the above-mentioned Wasm code, a variable whose index location is 0 in the 2^{nd} line is also assigned with a value of 0, that is, is located in the data segment. The 3^{rd} line and the 5^{th} line are main functions, including executing a print function and returning a value of a variable (namely, sum in the source code) whose index location is 0. The ellipsis in the 6^{th} line indicates bytecode corresponding to a Fibonacci function in the 7^{th} line to the 10^{th} line in the source code. The start function in the 7^{th} line to the 10^{th} line includes a result of assigning a value of fib(5) to a global variable, which corresponds to the operation in the global scope in the 11^{th} line. An operation in this type of global scope is suitable for being performed first in the start function. The 9^{th} line indicates that the start function is marked as the start function of the Wasm bytecode, namely, the entry function.

In this example, calculation of the Fibonacci function becomes complex. Each time the Wasm bytecode is loaded and run, the code in the start function is executed repeatedly, which generates large time and performance overheads. In particular, in many actual cases, the start function includes more complex code, for example, the above-mentioned underlying implementation in the standard library and initialization content related to calling, garbage collection, etc. of some construction functions.

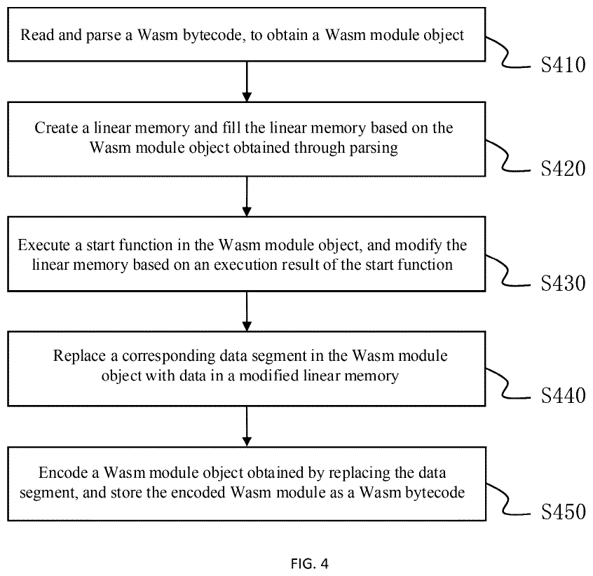

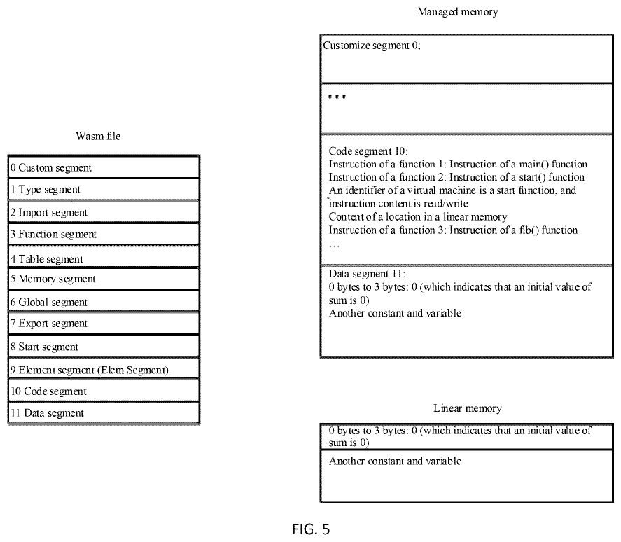

With reference to FIG. 4, the following describes how to provide optimized Wasm bytecode in one or more embodiments.

S410: Read and parse Wasm bytecode, to obtain a Wasm module object.

The to-be-optimized Wasm bytecode can be loaded by using a Wasm virtual machine. The Wasm bytecode can be specifically binary data of the Wasm bytecode, and can be obtained after a WebAssembly compiler compiles source code in a high-level language. Further, the loaded Wasm bytecode can be parsed by using the Wasm virtual machine, and parsing mainly includes a decoding process. A Wasm bytecode file is usually an encoded binary file. Through decoding, each section ID (namely, an ID in Table 1) in a Wasm module can be obtained based on a Wasm standard, and is further parsed to obtain detailed content in a section corresponding to each ID. As such, the Wasm module object can be obtained by parsing the Wasm bytecode, and can include start function code in a memory segment, a data segment, and a code segment (only code that is strongly associated with this embodiment is listed here. Actually, entire code is described in Table 1, and details are omitted).

In a specific implementation, for example, the above-mentioned code example of a Fibonacci function is used, and the Wasm module object obtained through parsing is as follows:

TABLE 2
Wasm module in a specific example

| ID | Segment | Description |
|---|---|---|
| 0 | Custom segment | Mainly used to store data such as debugging information |
| | (Custom) | |
| 1 | Type segment | Stores a function parameter list of an imported function and |
| | (Type) | module internal function |
| 2 | Import segment | Used to store a function name and a function parameter index of an |
| | (Import) | imported function |
| 3 | Function segment | Used to store a function index value |
| | (Function) | |
| 4 | Table segment | Used to store an object reference, where the table segment can |
| | (Table) | implement a function (call_indirect instruction) of a function |
| | | pointer, and can be imported from an external host or exported to |
| | | an external host environment |
| 5 | Memory segment | Used to store runtime dynamic data of a program, where the |
| | (Memory) | runtime dynamic data can be imported from an external host or |
| | | exported to an external host environment |
| 6 | Global segment | Used to store all variable values |
| | (Global) | |
| 7 | Export segment | Used to store a function name and a function parameter index of an |
| | (Export) | exported function |
| 8 | Start segment | Used to specify a function index value used when a module is |
| | (Start) | initialized |
| 9 | Element segment | A table segment is not explicitly initialized, and the element |
| | (Elem) | segment is used to store an index value of a function |
| 10 | Code segment | Used to store instruction code of a function |
| | (Code) | |
| 11 | Data segment | 0 bytes to 3 bytes: 0 (which indicates that an initial value of sum is |
| | (Data) | 0) |
| | | . . . |

This is mainly because in a data segment 11, values of the first four bytes are 0 (the first four bytes are 0 here because sum is the first described variable, and an int type occupies four bytes).

A result of loading the Wasm bytecode is that a decoded binary file of the Wasm bytecode is stored in a managed memory of a Wasm virtual machine, as shown in FIG. 5.

S420: Create a linear memory and fill the linear memory based on the Wasm module object obtained through parsing.

In an execution process, a Wasm instance is first created, and the linear memory is created based on the memory segment in the Wasm module object obtained through parsing in S410. As described above, a memory segment 5 can describe a basic situation of a linear memory segment used in a Wasm module, for example, an initial size and a maximum available size of the memory segment.

This process can be understood with reference to FIG. 3 and FIG. 5. A data segment 11 in the managed memory comes from a data segment 11 in a Wasm file. Certainly, entire content in the managed memory can be a copy of a binary file in one piece of Wasm bytecode.

After a segment of linear memory is created in the Wasm virtual machine based on the memory segment in the managed memory, content of the data segment 11 in the managed memory can be filled in the linear memory. As such, a value 0 of 0 bytes to 3 bytes in the above-mentioned example exists in the linear memory. The value is a value of sum in the above-mentioned code example. In addition, another constant and variable can be included in the linear memory, depending on a definition in actual code.

S430: Execute a start function in the Wasm module object, and modify the linear memory based on an execution result of the start function.

After the Wasm instance is created, the instance can be executed. An execution process includes: executing a start function copied to a code segment 10 in the managed memory. As described above, each time the Wasm module is executed after being loaded onto the virtual machine, the start function is equivalent to an entry of code. Therefore, content in the start function is executed, and then the remaining code is executed.

It is worthwhile to note that instance loading and execution are two processes obtained through subdivision. There can be correspondingly a plurality of times of execution after each time of loading, that is, a plurality of instances are started. After each instance is started, a linear memory corresponding to the instance can be created, and a process of filling content of the data segment in the managed memory into the linear memory and a process of finding the entry of the start function and first executing the start function are performed.

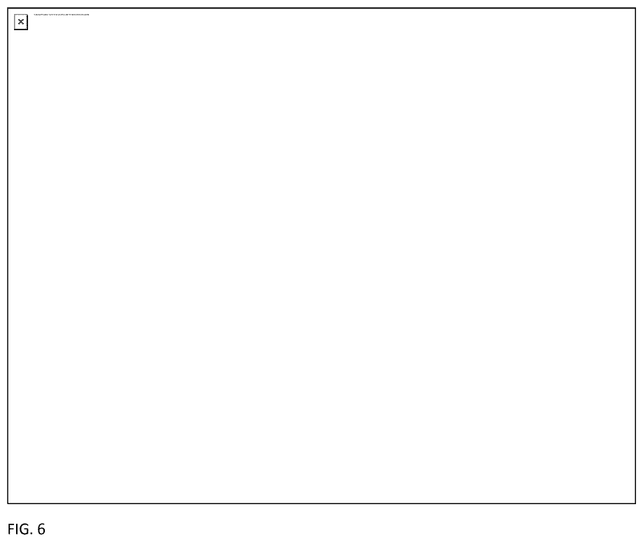

In the above-mentioned code example, the process of executing the start function specifically includes: calling a fib( ) function, and setting an input parameter to 5. An execution result of fib(5) is 5 (for a Fibonacci sequence starting from 1, the first five terms are 1-1-2-3-5, that is, the 5^{th} term is 5). Further, i32.store 0 (call fib 5)) in the Wasm bytecode is executed, that is, a value of sum in the source code is changed to 5. Modified sum=fib(5) is more complex than sum=1 existing before modification, because calling of the fib(5) function involves five iterations, and additional calculation overheads and time overheads need to be generated. As shown in FIG. 6, for the Wasm code, in an execution process of an instance, a result of executing the start function one time is that values of 0 bytes to 3 bytes in the linear memory are modified to 5 (an execution result of calling the fib(5) function is 5).

S440: Replace a corresponding data segment in the Wasm module object with data in a modified linear memory.

As described above, each time an instance is started, the start function is executed from the data segment 11 in the managed memory, and a result of executing the start function each time is fixed and the same. Therefore, the corresponding data segment in the Wasm module object can be replaced with the data in the modified linear memory. Specifically, if operation permission for the managed memory can be obtained, the corresponding data segment in the Wasm module object can be replaced with the data in the modified linear memory; or if operation permission for the managed memory cannot be obtained, the Wasm module object obtained through parsing in S410 can be stored in a memory area for which there is operation permission, and then the corresponding data segment in the Wasm module object is replaced with the data in the modified linear memory in the memory area for which there is operation permission.

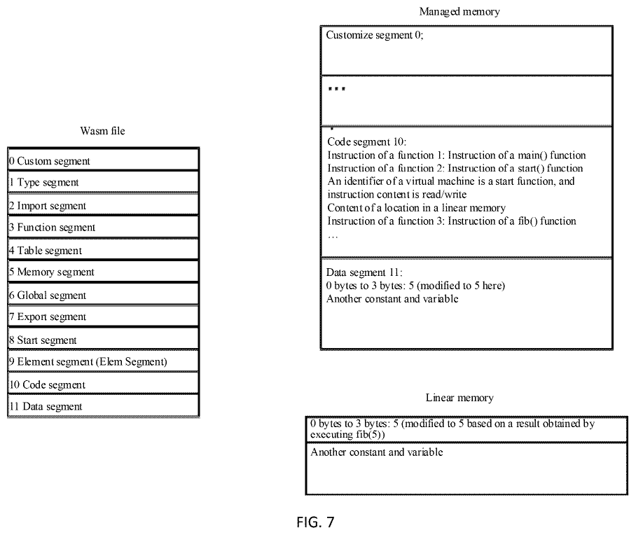

The former can be shown in FIG. 7. To be specific, when the operation permission for the managed memory can be obtained, the corresponding data segment in the Wasm module object stored in the managed memory can be replaced with the data in the modified linear memory. An overall structure of the latter is similar to that in FIG. 7, and a difference does not lie in managed memory for which there is no operation permission but lies in another memory for which there is operation permission. Certainly, the Wasm module object obtained through parsing in S410 can be stored in a memory other than the managed memory, regardless of whether there is operation permission.

For the above-mentioned modified example including the Fibonacci function, a result 5 of executing the Fibonacci function in the start function and 0 existing before execution both are of an int type, and both occupy four bytes, and another constant and variable in the linear memory are still consistent with another constant and variable in the data segment. As such, in an implementation, a corresponding part in the data segment in the Wasm module object can be replaced with a part that causes a change to the linear memory after the start function is executed. In this example, a value of 0 bytes to 3 bytes in the linear memory is replaced with the result 5 obtained by executing the start function, but the another constant and variable in the data segment are not replaced with the another constant and variable in the linear memory, thereby reducing overheads brought by copying.

Certainly, a result obtained after a function in the start function is executed may be greater than a corresponding part in the linear memory before execution. For example, the result is of a string type with a variable length. An initial value occupies 2 bytes. After the start function is executed, 5 bytes are occupied. In this case, a better method is replacing the corresponding data segment in the Wasm module object with the entire data in the modified linear memory.

In addition, a result obtained after a function in the start function is executed may be greater than a corresponding part in the linear memory before execution. For example, the result is of a string type with a variable length. An initial value occupies 5 bytes. After the start function is executed, 2 bytes are occupied. In this case, a better method is replacing the corresponding data segment in the Wasm module object with the entire data in the modified linear memory. A 3-byte hole is generated in the middle, and other code of a subsequent code segment can be used. In addition, a hole area can be removed from the data in the modified linear memory, and the corresponding data segment in the Wasm module object is replaced, thereby alleviating a problem of low addressing efficiency caused by subsequently using a part of hole memory.

S450: Encode a Wasm module object obtained by replacing the data segment, and store the encoded Wasm module as Wasm bytecode.

As described above, the Wasm bytecode file is usually encoded. Parsing the Wasm bytecode includes a decoding process. After the Wasm module object in the memory after the data segment is replaced in S440, the Wasm bytecode can be obtained through encoding, so that the Wasm bytecode can be stored outside the memory, for example, on a disk, or transmitted through a network. The Wasm bytecode, namely, the optimized Wasm bytecode is obtained through encoding.

Subsequently, the optimized Wasm bytecode is loaded, so that the Wasm module object in the memory can be obtained by directly parsing the optimized Wasm bytecode. Specifically, as described above, the managed memory of the Wasm virtual machine stores the decoded optimized Wasm module object, as shown in FIG. 7. Further, the linear memory can be created and filled based on the Wasm module object obtained through parsing. In addition, as described above, content of a current data segment is a result of loading the linear memory and modifying the linear memory based on the execution result after the start function is executed, each time an instance is started before optimization, and each such an operation has a fixed and same result. Therefore, the start function in the managed memory can be no longer executed here. As such, the start function can be further removed from the optimized Wasm bytecode. In other words, a start marker (start $start) of the start function is deleted, as shown in Form 1 below; or entire content of the start function is removed (this depends on whether other code in the start function is to be used), as shown in Form 2 below. In both methods, after the Wasm instance is started, code in the start function is not executed, but code corresponding to a main( )/apply( ) function is directly executed.

Specifically, after S430, before S450, the start function in the Wasm module object is removed, the data segment is replaced, and the Wasm module after the start function is removed is encoded and stored, to obtain the Wasm bytecode.

As such, the Wasm bytecode (pseudocode) generated by compiling the source code includes two forms:

Form 1 in which a start function is removed:

| 1. | ( | |
|---|---|---|
| 2. | (data 0 “\5”) | |
| 3. | (func $main | |
| 4. | | (print “hello”) |
| 5. | i32.load 0) | |
| 6. | ... | |
| 7. | (func $start | |
| 8. | | i32.store 0 (call fib 5)) |

[symbol]

//a strikethrough line means cancelling being marked as a start

function

| | |
|---|---|
| 10. | ) |

Form 2 in which a start function is removed:

| 1. | ( | |
|---|---|---|
| 2. | (data 0 “\5”) | |
| 3. | (func $main | |
| 4. | | (print “hello”) |

| | |
|---|---|
| 5. | i32.load 0) |
| 6. | ... |

[symbol]

[symbol]

[symbol]

[symbol]

//a strikethrough line means that entire content of a start function is
deleted

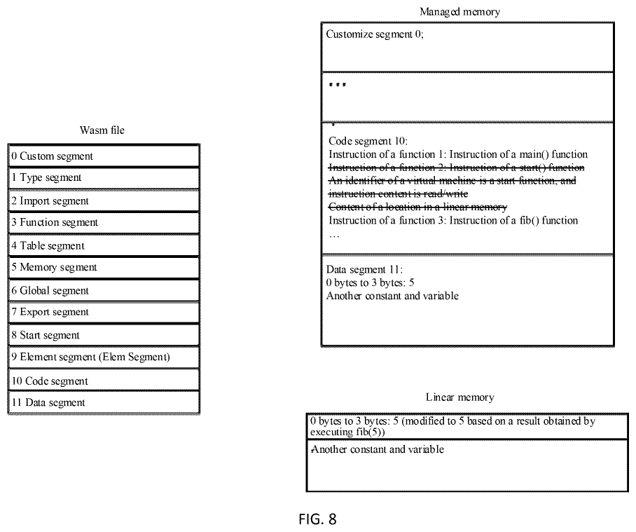

Correspondingly, as shown in FIG. 8, the start function in the managed memory can be removed, which can be specifically the above-mentioned two forms.

The blockchain 1.0 era usually refers to a development phase of blockchain applications represented by bitcoin between 2009 and 2014, and is mainly focused on resolving decentralization of currency and payment methods Since 2014, developers have increasingly focused on addressing technical and scalability deficiencies of bitcoins. At the end of 2013, Vitalik Buterin released an Ethereum white paper “Ethereum: Next Generation of Smart Contracts and Decentralized Application Platform”, which introduced smart contracts into the blockchain and opened an application of blockchain outside the currency field, thus opening the era of blockchain 2.0.

The smart contract is a computer contract that can be automatically executed based on stipulation triggered rules, which can also be regarded as a digital version of a traditional contract. The concept of smart contracts was first proposed by Nick Szabo, an interdisciplinary legal scholar and cryptography researcher, in 1994. This technology was once not used in a real industry due to the lack of programmable digital systems and related technologies, until the emergence of blockchain technology and Ethereum, which provided a reliable execution environment. Due to a block chain ledger adopted by the blockchain technology, data generated cannot be tampered with or deleted, and data would be continuously added to the entire ledger, thus ensuring the traceability of historical data. At the same time, the decentralized operation mechanism avoids the influence of centralized factors. The smart contract based on the blockchain technology can not only give full play to advantages of smart contracts in terms of costs and efficiency, but also avoid interference of malicious behaviors on normal execution of the contracts. The smart contract is written into the blockchain in a digital form, and characteristics of the blockchain technology ensure that whole processes of storage, reading, and execution are transparent and traceable, and cannot be tampered with.

The smart contract is essentially a program that can be executed by a computer. The smart contract, like today's widely used computer programs, can be written in high-level languages. For example, Ethereum and some Ethereum-based alliance chains would generally provide native smart contracts written in high-level languages such as Solidity, Serpent, and LLL. The smart contracts written in these high-level languages can include various complex logics to achieve various service functions. The core of Ethereum as a programmable blockchain is the Ethereum Virtual Machine (EVM), which can be run by every Ethereum node. The EVM is a Turing-complete virtual machine, which means that various complex logics can be implemented through it. A user publishing and calling the smart contract in Ethereum can run on the EVM. In fact, the virtual machine directly runs virtual machine code (virtual machine bytecode, or “bytecode”). The smart contract deployed in the blockchain can be in the form of bytecode.

In addition, as a decentralized distributed system, the blockchain needs to maintain distributed consistency. Specifically, each node in a group of nodes in the distributed system is provided with a state machine therein. Each state machine needs to execute same instructions in a same order from a same initial state, keeping each state change the same, so as to ensure that a final consistent state is reached. However, it is difficult for each node device participating in a same blockchain network to have the same hardware configuration and software environment. Therefore, in Ethereum, the representative of blockchain 2.0, in order to ensure that the process and result of the execution of the smart contract on each node are the same, a Virtual Machine similar to the JVM, i.e., an Ethereum Virtual Machine (EVM), is used. Differences in hardware configuration and software environment of each node can be shielded by EVM, and sandbox-like environments of the EVM can also ensure that the execution of the smart contract would not affect blockchain platform codes, other programs, or operating systems on a host. As such, the developers can develop a set of codes of the smart contract, and upload the compiled bytecode to the blockchain after the developers compiles the codes of the smart contract locally. After each node executes the same bytecode through the same EVM at the same initial state, the same final result and the same intermediate result can be obtained, and underlying hardware and environment differences of different nodes can be shielded.

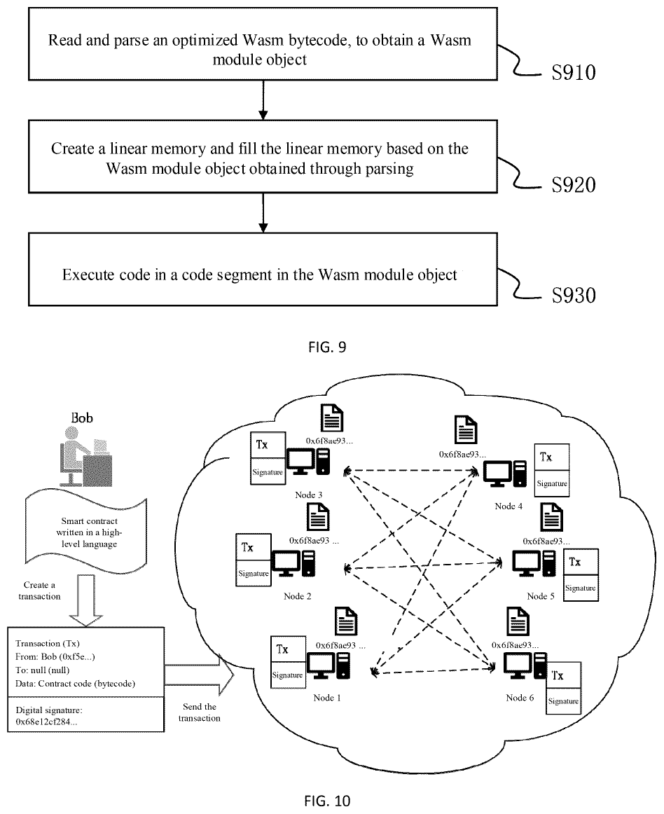

For example, as shown in FIG. 10, after Bob sends a transaction that includes information for creating a smart contract to the Ethereum network, an EVM of a node 1 can execute the transaction and generate a corresponding contract instance. The Data field of the transaction can store the bytecode of the contract, and the to field of the transaction can be an empty address. After the nodes reach consensus through the consensus mechanism, the smart contract can be successfully created on the blockchain. “0x6f8ae93 . . . ” in FIG. 10 represents the address of the successfully created smart contract, through which subsequent users can call the contract. After the contract is created, a contract account corresponding to the contract address of “0x6f8ae93 . . . ” appears on the blockchain, the contract code and the account storage can be stored in the contract account. The behavior of the smart contract is controlled by the contract code, while the account storage of the smart contract stores the state of the contract. In other words, the smart contract makes a virtual account including the contract code and the account storage be generated in the blockchain.

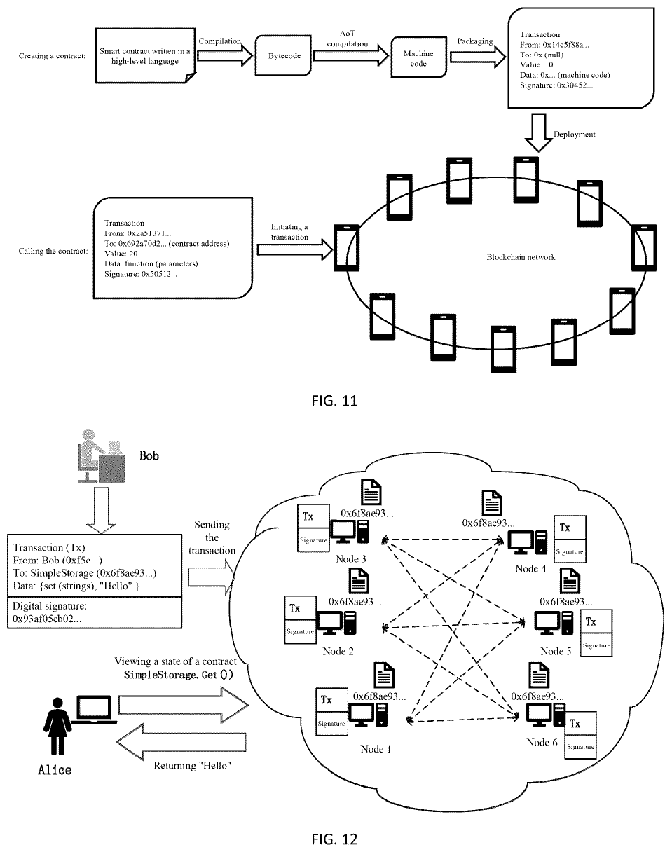

As mentioned above, the Data field of the transaction including creation of the smart contract can store bytecode of the smart contract. The bytecode consists of a sequence of bytes, each byte can indicate an operation. On the basis of development efficiency, readability, and other considerations, developers can not directly write bytecode, but choose a high-level language to write the smart contract code. The smart contract code written in the high-level language is compiled by a compiler to generate bytecode, which can then be packaged into the initiated transaction and deployed on the blockchain through the aforementioned consensus and execution process, as shown in FIG. 11.

As shown in FIG. 11 and FIG. 12, still taking Ethereum as an example, after Bob sends a transaction including calling information of the smart contract to the Ethereum network, the EVM of node 1 can execute this transaction and generate a corresponding contract instance. In FIG. 12, a From field of the transaction is an address of the account that initiates calling of the smart contract, “0x6f8ae93 . . . ” in a To field represents an address of the called smart contract, a Value field represents a value of Ethercoin in Ethereum, and a Data field of the transaction stores methods and parameters for calling the smart contract. After the smart contract is called, the value of “balance” may change. Then, a certain client may check a current value of the balance through a certain blockchain node. The smart contract can be executed independently by each node in the blockchain network in a prescribed way, and all execution records and data are stored on the blockchain. Hence, when such transactions are completed, transaction vouchers that cannot be tampered with and cannot be lost are stored on the blockchain.

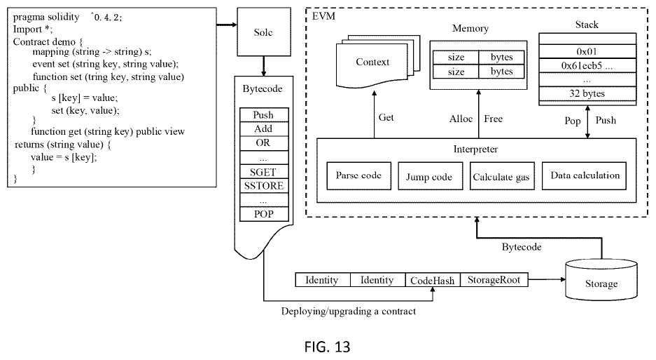

As mentioned above, the transaction for creating a smart contract is sent to the blockchain, and after consensus, each node of the blockchain can execute the transaction. Specifically, the EVM virtual machine of the blockchain node can execute the transaction. At this time, a contract account corresponding to the smart contract appears on the blockchain (including, such as an identity, Identity, of the account, a hash value, Codehash, of the contract, and a root, StorageRoot, of the contract storage), and has a specific address. The contract code and account storage can be stored in the storage of the contract account, as shown in FIG. 13. The behavior of the smart contract is controlled by the contract code, while the account storage of the smart contract stores the state of the contract. In other words, the smart contract makes a virtual account including the contract code and the account storage be generated in the blockchain. For a contract deployment transaction or a contract update transaction, the value of Codehash will be generated or changed. Subsequently, the blockchain node can receive a transaction request calling the deployed smart contract, and the transaction request can include the address of the called contract, a function in the called contract, and an input parameter. Generally, after consensus on the transaction request is reached, each node in the blockchain can independently execute the smart contract that is designated to be called.

The left side of FIG. 13 shows an example of a smart contract written in solidity. The smart contract is compiled by a compiler to generate bytecode. solc in the drawing is a solidity's command-line compiler. The Ethereum smart contract compiled by solidity can be compiled by solc, a command-line tool with parameters, to generate the bytecode that can be run on the EVM. After the process of deploying the contract in FIG. 10 and FIG. 11 above, the smart contract can be successfully created on the blockchain. After the contract is deployed, a contract account corresponding to the smart contract appears on the blockchain. The contract account includes, such as an identity, Identity, of the account, a hash value, Codehash, of the contract, and a root, StorageRoot, of the contract storage, and has a specific address. The contract code and account storage can be stored in the storage of the contract account. Codehash is generally the hash value of the contract bytecode. After the contract is deployed, Codehash is the hash value of the contract bytecode. When the contract is updated, the hash of the contract bytecode would generally change, and Codehash would also generally be updated.

The execution of the contract can be specifically shown in FIG. 13. For example, a transaction for calling the contract is sent to the blockchain network, and after consensus, each node can execute the transaction. The to field of the transaction indicates the address of the called contract. Any node can find the storage of the contract account according to the address of the contract, and then can read the Codehash from the storage of the contract account, so as to find the corresponding contract bytecode according to the Codehash. The node can load the bytecode of the contract from the storage to the virtual machine. Furthermore, it is interpreted and executed by an interpreter, for example, including: parsing the bytecode of the called contract (parse, such as Push, Add, SGET, SSTORE, and Pop), to obtain OPcode and functions, storing these OPcode to a memory opened by the virtual machine (alloc, after the program is executed, a corresponding memory releasing operation, for example, Free in the drawing), and at the same time, also obtaining a JumpCode of the called function in the memory. Generally, after calculating the Gas needed to be consumed for executing the contract and Gas being sufficient, it is jumped to the corresponding address of the memory to obtain the OPcode of the called function and start to execute. Data Computation, push/push Stack and other operations are performed on the data operated by the OPcode of the called function, to complete the data computation. In this process, some contract context information may also be needed, such as the block number, and information of an initiator for calling the contract; the information can be obtained from the Context (Get operation). Finally, the generated state is stored in a database storage by calling a storage interface. It is worthwhile to note that in the process of contract creation, it may also produce the execution of some functions in the contract, for example, the function of an initialization operation. At this time, the code will also be parsed, the jump instructions will be generated, the Memory will be stored, the data will be operated in the Stack, etc.

In fact, C language, C++ language, Java language, Go language, Python language, and other high-level languages also have some advantages. For example, C language is more efficient; C++ and Java have a wide audience, a large number of developers, and mature communities and tools. Go language is more modern; Python language is relatively simple to use. At present, all blockchain platforms are extending smart contract types to smart contracts supporting development by high-level languages such as C, C++, Java, Go, and Python languages. After extending to the smart contracts supporting development by the high-level languages, one implementing mode is to compile contract bytecode in a wasm (WebAssembly) format. WebAssembly is an open standard developed by a W3C community group, is a secure, portable low-level code format specially designed for efficient execution and compact presentation, can run with near-native performances, and provides a compilation target for languages such as C, C++, Java, and Go. Originally designed purpose of the WASM virtual machine is to solve the growing bad performance problems of Web applications. The WASM virtual machine has been adopted by an increasing number of non-Web items due to its superior characteristics, such as replacing the smart contract execution engine EVM. The WebAssembly virtual machine (which also known as the Wasm virtual machine or Wasm running environment, and is the virtual machine running environment for executing the WASM bytecode) implemented based on the W3C community open standards is implemented by loading the Wasm bytecode during running and interpreting and executing the Wasm bytecode. The execution process of the Wasm bytecode in the Wasm virtual machine is also similar to the EVM process described above, as shown in FIG. 13.

The following describes one or more embodiments of a method for executing an optimized Wasm bytecode according to this application. As shown in FIG. 9, the method includes the following steps.

S910: Read and parse the optimized Wasm bytecode, to obtain a Wasm module object.

S920: Create a linear memory and fill the linear memory based on the Wasm module object obtained through parsing.

S930: Execute code in a code segment in the Wasm module object.

When the code segment in the Wasm module object does not include a start function, the start function is not executed; when the code segment in the Wasm module object still includes a start function, that is, the start function is not removed from the optimized Wasm bytecode, but code marked as the start function is cancelled, the start function is skipped, and the code in the code segment in the Wasm module object is directly executed.

As such, in a subsequent process of loading and executing the optimized Wasm bytecode, overheads caused by repeatedly executing the start function are avoided, thereby improving program running performance.

The following describes one or more embodiments of a computer device according to this application. The computer device includes: a processor; and a storage, where the storage stores a program, and when the processor executes the program, the following operations are performed: reading and parsing an optimized Wasm bytecode, to obtain a Wasm module object; creating a linear memory and filling the linear memory based on the Wasm module object obtained through parsing; and executing code in a code segment in the Wasm module object.

The following describes one or more embodiments of a storage medium according to this application. The storage medium is configured to store a program, and when the program is executed, the following operations are performed: reading and parsing Wasm bytecode, to obtain a Wasm module object; creating a linear memory and filling the linear memory based on the Wasm module object obtained through parsing; executing a start function in the Wasm module object, and modifying the linear memory based on an execution result of the start function; replacing a corresponding data segment in the Wasm module object with data in a modified linear memory; and encoding a Wasm module obtained by replacing the data segment, and storing the encoded Wasm module as Wasm bytecode.

In the 1990s, whether a technical improvement is a hardware improvement (for example, an improvement to a circuit structure, such as a diode, a transistor, or a switch) or a software improvement (an improvement to a method procedure) can be clearly distinguished. However, as technologies develop, current improvements to many method procedures can be considered as direct improvements to hardware circuit structures. Almost all designers obtain the corresponding hardware circuit structure by programming the improved method process into the hardware circuit. Therefore, a method procedure can be improved by using a hardware entity module. For example, a programmable logic device (PLD) (for example, a field programmable gate array (FPGA)) is such an integrated circuit, and a logical function of the PLD is determined by a user through device programming. The designer performs programming to “integrate” a digital system into a PLD without requesting a chip manufacturer to design and produce an application-specific integrated circuit chip. In addition, currently, instead of manually manufacturing an integrated circuit chip, such programming is mostly implemented by using “logic compiler” software. The “logic compiler” software is similar to a software compiler used to develop and write a program. Original code needs to be written in a particular programming language before being compiled. The language is referred to as a hardware description language (HDL). There are many HDLs such as the Advanced Boolean Expression Language (ABEL), the Altera Hardware Description Language (AHDL), Confluence, the Cornell University Programming Language (CUPL), HDCal, the Java Hardware Description Language (JHDL), Lava, Lola, MyHDL, PALASM, and the Ruby Hardware Description Language (RHDL). Currently, the Very-High-Speed Integrated Circuit Hardware Description Language (VHDL) and Verilog are most commonly used. It should also be clear to a person skilled in the art that a hardware circuit for implementing a logical method procedure can be easily obtained by performing slight logic programming on the method procedure by using the above-mentioned several hardware description languages and programming the method procedure into an integrated circuit.

A controller can be implemented by using any appropriate method. For example, the controller can be a microprocessor or a processor, or a computer-readable medium that stores computer readable program code (such as software or firmware) that can be executed by the microprocessor or the processor, a logic gate, a switch, an application-specific integrated circuit (ASIC), a programmable logic controller, or an embedded microprocessor. Examples of the controller include but are not limited to the following microprocessors: ARC 625D, Atmel AT91SAM, Microchip PIC18F26K20, and Silicon Labs C8051F320. The memory controller can also be implemented as a part of control logic of a storage. A person skilled in the art also knows that in addition to implementing the controller by using only the computer-readable program code, logic programming can be performed on method steps to enable the controller to implement the same function in a form of a logic gate, a switch, an application-specific integrated circuit, a programmable logic controller, an embedded microcontroller, etc. Therefore, the controller can be considered as a hardware component, and an apparatus that is configured to implement various functions and that is included in the controller can also be considered as a structure in the hardware component. Alternatively, the apparatus configured to implement various functions can even be considered as both a software module implementing a method and a structure in the hardware component.

Systems, apparatuses, modules, or units that are set forth in the above-mentioned implementations can be embodied by a computer chip or an entity or by a product with a specific function. A typical implementation device is a server system. Certainly, this application does not exclude that with development of future computer technologies, a computer that implements a function of the above-mentioned embodiment can be, for example, a personal computer, a laptop computer, a vehicle-mounted man-machine interaction device, a cellular phone, a camera phone, a smartphone, a personal digital assistant, a media player, a navigation device, an e-mail device, a game console, a tablet computer, a wearable device, or a combination of any of these devices.

Although one or more embodiments of this specification provide method operating steps as described in the embodiments or a flowchart, more or fewer operating steps may be included on the basis of conventional or noncreative means. A sequence of steps listed in the embodiments is merely one of various step execution sequences and does not indicate a sole execution sequence. In practice, when being executed by an apparatus or an end-user device product, the steps can be performed sequentially or in parallel (for example, by parallel processors or in a multi-thread processing environment, or even in a distributed data processing environment) based on the method shown in the embodiments or the accompanying drawings. The terms “include”, “comprise”, or any other variants thereof are intended to cover a non-exclusive inclusion, so that a process, a method, a product, or a device that includes a list of elements not only includes those elements but also includes other elements that are not expressly listed, or further includes elements inherent to such a process, method, product, or device. Without more constraints, the existence of additional identical or equivalent elements in the process, method, product, or device that includes the elements is not excluded. For example, if the words first, second, etc. are used for indicating names, they do not indicate any particular order.

For ease of description, the above-mentioned apparatus is described by dividing functions into various modules. Certainly, during implementation of one or more embodiments of this specification, the functions of the modules can be implemented in same one or more pieces of software and/or hardware, or modules implementing the same function can be implemented by using a combination of a plurality of sub-modules or sub-units, etc. The described apparatus embodiments are merely examples. For example, division into the units is merely logical function division and there can be other division methods in actual implementation. For example, a plurality of units or components can be combined or integrated into another system, or some features can be ignored or not performed. In addition, the displayed or discussed mutual couplings or direct couplings or communication connections can be implemented by using some interfaces. The indirect couplings or communication connections between the apparatuses or units can be implemented in electronic, mechanical, or other forms.

This application is described with reference to a flowchart and/or a block diagram of a method, an apparatus (system), and a computer program product according to some embodiments of this application. It should be understood that computer program instructions may be used to implement each process and/or each block in the flowcharts and/or the block diagrams and a combination of a process and/or a block in the flowcharts and/or the block diagrams. These computer program instructions can be provided to a general-purpose computer, a special-purpose computer, an embedded processor, or a processor of another programmable data processing device to generate a machine, so that the instructions executed by the computer or the processor of the another programmable data processing device generate an apparatus for implementing a specific function in one or more procedures in the flowcharts and/or in one or more blocks in the block diagrams.

These computer program instructions may be stored in a computer-readable storage that can instruct the computer or any other programmable data processing device to work in a specific method, so that the instructions stored in the computer-readable storage generate an artifact that includes an instruction apparatus. The instruction apparatus implements a specific function in one or more processes in the flowcharts and/or in one or more blocks in the block diagrams.

Alternatively, these computer program instructions can be loaded onto a computer or another programmable data processing device, so that a series of operations and steps are performed on the computer or the another programmable device, to generate computer-implemented processing. Therefore, the instructions executed on the computer or the another programmable device provide steps for implementing a specific function in one or more procedures in the flowcharts and/or in one or more blocks in the block diagrams.

In a typical configuration, a computing device includes one or more central processing units (CPU), input/output interfaces, network interfaces, and memories.

The memory can include a non-persistent storage, a random access memory (RAM), a nonvolatile memory, and/or another form in a computer-readable medium, for example, a read-only memory (ROM) or a flash random access memory (flash RAM). The memory is an example of the computer-readable medium.

Computer-readable media, including permanent and non-permanent, removable and non-removable media, can be implemented by any method or technology for information storage. The information can be computer-readable instructions, a data structure, a program module, or other data. Examples of the computer storage medium include but are not limited to a phase change random access memory (PRAM), a static random access memory (SRAM), a dynamic random access memory (DRAM), another type of RAM, a ROM, an electrically erasable programmable read-only memory (EEPROM), a flash memory or another memory technology, a compact disc read-only memory (CD-ROM), a digital versatile disc (DVD) or another optical storage, a cassette magnetic tape, a magnetic tape/magnetic disk storage, another magnetic storage device, or any other non-transmission medium. The computer storage medium can be used to store information accessible by a computing device. As described in this specification, the computer-readable medium does not include computer-readable transitory media such as a modulated data signal and a carrier.

A person skilled in the art should understand that one or more embodiments of this specification can be provided as methods, systems, or computer program products. Therefore, the one or more embodiments of this specification can use a form of hardware only embodiments, software only embodiments, or embodiments with a combination of software and hardware. Moreover, the one or more embodiments of this specification can use the form of a computer program product implemented on one or more computer available storage media (including, but not limited to, disk storage, CD-ROM, optical memory, etc.), where the computer available program code is included.

The one or more embodiments of this specification can be described in a common context of a computer executable instruction executed by a computer, for example, a program module. Typically, program modules include routines, programs, objects, components, data structures, etc. that perform specific tasks or implement specific abstract data types. The one or more embodiments of this specification can also be practiced in a distributed computing environment where tasks are performed by remote processing devices that are connected through a communication network. In a distributed computing environment, the program module can be located in both local and remote computer storage media including storage devices.

The embodiments of this specification are described in a progressive method. For same or similar parts in the embodiments, references can be made to each other. Each embodiment focuses on a difference from another embodiment. Particularly, the system embodiments are basically similar to the method embodiments, and therefore are described briefly. For related parts, reference can be made to some descriptions in the method embodiments. In the description of this specification, references to term “an embodiment”, “some embodiments”, “examples”, “specific examples”, or “some examples” mean that specific features, structures, materials, or characteristics described in conjunction with this embodiment or example are included in at least one embodiment or example of this specification. In this specification, it is unnecessary for the explanatory representation of the above-mentioned terms to refer to the same embodiment or example. Moreover, the specific features, structures, materials, or characteristics described can be combined in any one or more embodiments or examples in a suitable method. In addition, without contradicting each other, a person skilled in the art can combine and integrate different embodiments or examples described in this specification and features of the different embodiments or examples.

The above-mentioned descriptions are merely embodiments of the one or more embodiments of this specification, and are not intended to limit the one or more embodiments of this specification. A person skilled in the art knows that one or more embodiments of this specification can have various modifications and changes. Any modifications, equivalent replacements, improvements, etc. made without departing from the spirit and principle of this specification shall fall within the scope of the claims.

1. A method comprising:
parsing WebAssembly (Wasm) bytecode to obtain a Wasm module object;
generating a linear memory and filling the linear memory based on the Wasm module object;
executing a start function in the Wasm module object to obtain an execution result;
modifying the linear memory based on the execution result of the start function;
replacing a corresponding data segment in the Wasm module object with data in a modified linear memory to obtain a Wasm module; and
encoding the Wasm module and storing the encoded Wasm module as Wasm bytecode.

2. The method according to claim 1, wherein the method further comprises:
removing the start function from the Wasm module object before encoding the Wasm module.

3. The method according to claim 1, wherein removing the start function from the Wasm module object comprises:
deleting a start marker of the start function; or
removing entire content of the start function.

4. The method according to claim 1, wherein the Wasm module object is stored in a managed memory or a memory other than the managed memory.

5. The method according to claim 4, wherein a corresponding data segment in a Wasm module object stored in the managed memory or the memory other than the managed memory is replaced with the data in the modified linear memory.

6. The method according to claim 1, wherein replacing the corresponding data segment in the Wasm module object with data in the modified linear memory comprises:
replacing a corresponding part in the data segment in the Wasm module object with a part that causes a change to the linear memory after the start function is executed; or
replacing the corresponding data segment in the Wasm module object with entire data in the modified linear memory.

7. The method according to claim 1, wherein replacing the corresponding data segment in the Wasm module object with data in the modified linear memory comprises:
removing a hole area from the data in the modified linear memory; and
replacing the corresponding data segment in the Wasm module object.

8. A computing device, comprising:
at least one processor; and
a memory coupled to the at least one processor and stores programming instructions for execution by the at least one processor to perform operations comprising:
parsing WebAssembly (Wasm) bytecode to obtain a Wasm module object;
generating a linear memory and filling the linear memory based on the Wasm module object;
executing a start function in the Wasm module object to obtain an execution result;
modifying the linear memory based on the execution result of the start function;
replacing a corresponding data segment in the Wasm module object with data in a modified linear memory to obtain a Wasm module; and
encoding the Wasm module and storing the encoded Wasm module as Wasm bytecode.

9. The computing device according to claim 8, wherein the operations comprise:
removing the start function from the Wasm module object before encoding the Wasm module.

10. The computing device according to claim 8, wherein removing the start function from the Wasm module object comprises:
deleting a start marker of the start function; or
removing entire content of the start function.

11. The computing device according to claim 8, wherein the Wasm module object is stored in a managed memory or a memory other than the managed memory.

12. The computing device according to claim 11, wherein a corresponding data segment in a Wasm module object stored in the managed memory or the memory other than the managed memory is replaced with the data in the modified linear memory.

13. The computing device according to claim 8, wherein replacing the corresponding data segment in the Wasm module object with data in the modified linear memory comprises:
replacing a corresponding part in the data segment in the Wasm module object with a part that causes a change to the linear memory after the start function is executed; or
replacing the corresponding data segment in the Wasm module object with entire data in the modified linear memory.

14. The computing device according to claim 8, wherein replacing the corresponding data segment in the Wasm module object with data in the modified linear memory comprises:
removing a hole area from the data in the modified linear memory; and
replacing the corresponding data segment in the Wasm module object.

15. A non-transitory, computer-readable medium storing one or more instructions executable by at least one processor to perform operations comprising:
reading and parsing Wasm bytecode, to obtain a Wasm module object;
creating a linear memory and filling the linear memory based on the Wasm module object obtained through parsing;
executing a start function in the Wasm module object, and modifying the linear memory based on an execution result of the start function;
replacing a corresponding data segment in the Wasm module object with data in a modified linear memory; and
encoding a Wasm module obtained by replacing the data segment, and storing the encoded Wasm module as Wasm bytecode.

16. The non-transitory, computer-readable medium according to claim 15, wherein the operations comprise:
removing the start function from the Wasm module object before encoding the Wasm module.

17. The non-transitory, computer-readable medium according to claim 15, wherein removing the start function from the Wasm module object comprises:
deleting a start marker of the start function; or
removing entire content of the start function.

18. The non-transitory, computer-readable medium according to claim 15, wherein the Wasm module object is stored in a managed memory or a memory other than the managed memory.

19. The non-transitory, computer-readable medium according to claim 18, wherein a corresponding data segment in a Wasm module object stored in the managed memory or the memory other than the managed memory is replaced with the data in the modified linear memory.

20. The non-transitory, computer-readable medium according to claim 15, wherein replacing the corresponding data segment in the Wasm module object with data in the modified linear memory comprises:
replacing a corresponding part in the data segment in the Wasm module object with a part that causes a change to the linear memory after the start function is executed; or
replacing the corresponding data segment in the Wasm module object with entire data in the modified linear memory.
